(19) United States
(12) Patent Application Publication
(10) Pub. No.: US 2011/0228379 A1
(43) Pub. Date: Sep. 22, 2011

(54) Optical Tag

(75) Inventors: Paul David Mason, Worcestershire (GB); David Arthur Orchard, Worcestershire (GB); Andrew Maxwell Scott, Worcestershire (GB); Kevin Michael Brunson, Worcestershire (GB); Mark Edward McNie, Worcestershire (GB)

(73) Assignee: QINETIQ LIMITED, Hampshire (UK)

(21) Appl. No.: 13/131,673

(22) PCT Filed: Nov. 25, 2009
(86) PCT No.: PCT/GB2009/002746

§ 371 Date: May 27, 2011

(30) Foreign Application Priority Data
Dec. 5, 2008 (GB) 0822249.9

(51) Int. Cl. G02B 5/122; G02B 26/00; C03C 27/00; C03B 11/00

(52) U.S. Cl. 359/296; 359/529; 65/102; 65/43

(57) ABSTRACT

An optical tag (200) comprises a chalcogenide glass corner-cube reflector (202) bonded to a silicon MEMS modulator (206) by means of a glass material (214) having a lower softening temperature than that of the reflector. The tag is provided with AR coatings (210, 212). The invention provides a robust, integrated and compact optical tag having a wide field of view and low manufacturing costs.

The invention relates to optical reflectors of a type which can be remotely interrogated to yield information (whether temporarily or permanently stored by the tag), and to methods of making such reflectors. Where such optical reflectors are to be attached to an object in order to allow the object to be detected, tracked or classified, they are typically referred to as “optical tags”.

Known tagging systems have in common the basic concept of utilising a compact optically reflective tag which may be affixed to a vehicle, container, person etc. The tag may be remotely illuminated (interrogated) by a laser and light reflected from the tag may then be detected by means of a suitable optical detector to infer the presence of a tagged object. Such detection may also be accompanied by analysis of one or more properties of the reflected light to gain more specific information from the tag, for example information relating to the tagged object.

The essential elements of an optical tag are (i) a device which modifies at least one property of incident light, and (ii) a reflector for re-directing modified incident light towards a detector. A dynamic optical tag is one in which the modifying effect of the tag on the interrogating light may be changed over time, e.g. the modifying effect could be modulated. A number of technologies for dynamic optical tags are described in published UK patent application GB 2 437 419A.

A disadvantage with existing optical tags is that they may only be interrogated from directions lying within a small solid angle (i.e. they have a narrow field of view) because such tags typically comprise corner-cube reflectors having a relatively low refractive index.

The invention provides an optical tag comprising modifying means arranged to modify at least one property of light incident thereon and an associated corner-cube reflector arranged to reflect light output by said means away from the optical tag, wherein said reflector is a chalcogenide glass corner-cube reflector. The high refractive index of chalcogenide glass provides an optical tag having a wide field of view.

The chalcogenide glass corner-cube reflector may be arranged to retro-reflect light output by the modifying means back through the modifying means. In other words incident light may pass through the modifying means and be retro-reflected by the corner-cube reflector prior to passing back through the modifying means.

The modifying means may be bonded to the chalcogenide corner-cube reflector to form an integrated optical tag. For example the modifying means may be a silicon MEMS modulator bonded to the corner-cube reflector. (MEMS=micro electro-mechanical system.)

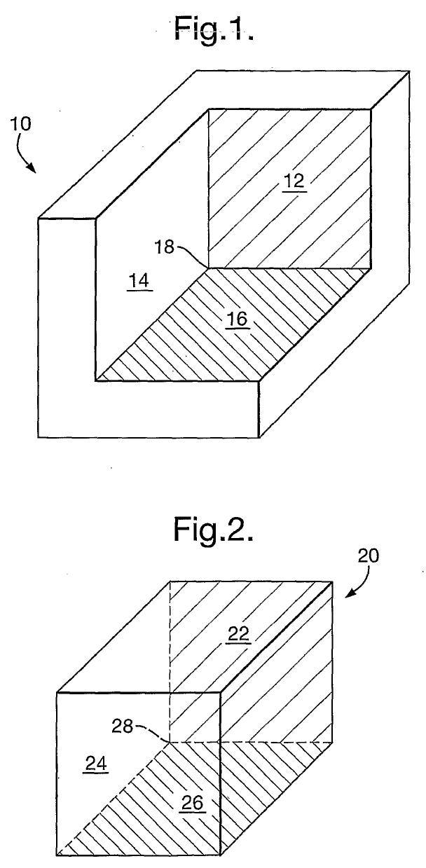

An optical tag of the invention may be of an array type, i.e. it may consist of a plurality of modifying means each having an associated corner-cube reflector. An example of this type of tag is shown in FIG. 1 of published UK patent application 2 437 419A.

Preferably the chalcogenide glass corner-cube reflector of the optical tag is made by the steps of:

(i) introducing a chalcogenide glass charge into a mould having three mutually orthogonal moulding surfaces forming an internal corner-cube;
(ii) heating the chalcogenide glass charge to form a softened chalcogenide glass charge; and
(iii) stamping the softened chalcogenide glass charge into the internal corner-cube in the general direction of the apex thereof to produce an external chalcogenide glass corner-cube.

This provides an optical tag having a highly accurate chalcogenide glass corner-cube reflector, but which is cheaper and simpler to fabricate than an optical tag comprising such a reflector which is made by cutting and polishing methods. The planarity and mutual orthogonality of the reflecting surfaces of the chalcogenide glass corner-cube reflector are improved compared to those of such corner-cube reflectors made by conventional moulding processes. The three mutually orthogonal surfaces of the chalcogenide glass corner-cube reflector may be coated with a metal or a dielectric coating to improve the reflectivity of the tag.

The softened chalcogenide glass charge may be stamped so as to produce a surface of optical quality on the side of the chalcogenide glass charge remote from the external corner-cube to produce an optical window which allows light to pass to the resulting corner-cube in use of the tag. The surface may be flat or curved, for example it may have spherical curvature. The softened charge may be stamped so that the surface is textured to provide and optical function, e.g. a moth-eye AR pattern may be applied.

The softened charge may be stamped so as to provide the chalcogenide glass corner-cube reflector with a peripheral raised edge facilitating bonding of the reflector to the light-modifying means. Where the light modifying means is a silicon MEMS modulator, the chalcogenide glass corner-cube reflector may be bonded to the silicon MEMS modulator by the steps of:

(i) introducing glass material between the chalcogenide glass corner-cube reflector and the silicon MEMS modulator, the glass material having a softening temperature less than that of the chalcogenide glass corner-cube reflector;
(ii) placing the corner-cube reflector, the glass material and the silicon MEMS modulator in contact;
(iii) heating the corner-cube reflector, the glass material and the silicon MEMS modulator to a temperature above the softening temperature of the glass material; and
(iv) applying force to allow the corner-cube reflector, the glass material and the silicon MEMS modulator to fuse together under heating.

Step (i) may be carried out by sputtering glass material onto at least a portion of a surface of the glass corner-cube reflector, or onto at least a portion of the silicon MEMS modulator. Alternatively a glass fillet may be introduced between the corner-cube reflector and the silicon MEMS modulator. Steps (iii) and (iv) may be carried out under vacuum to provide vacuum encapsulation.

Embodiments of the invention are described below with reference to the accompanying drawings in which:

FIGS. 1 & 2 show internal and external corner cubes;

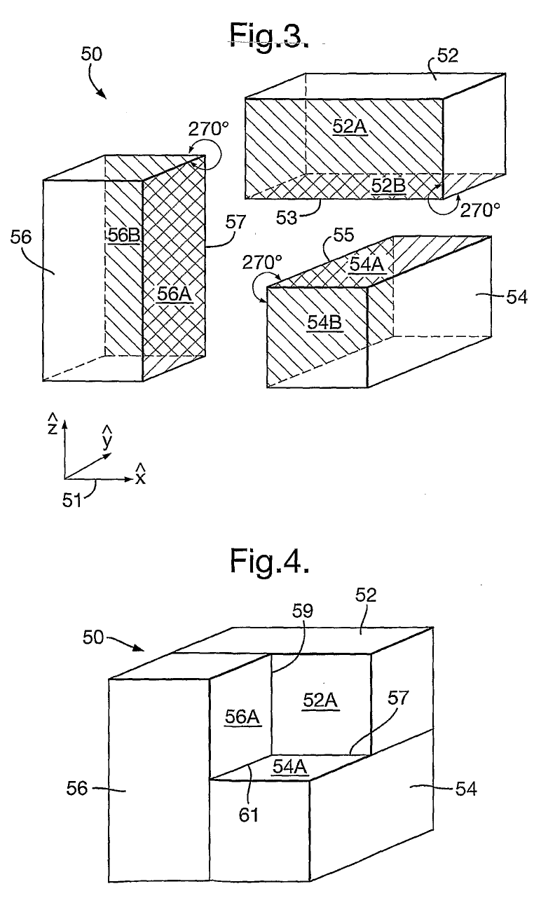

FIG. 3 shows a mould comprising three cuboid mould elements;

FIG. 4 shows the FIG. 3 mould elements arranged to form an internal corner-cube;

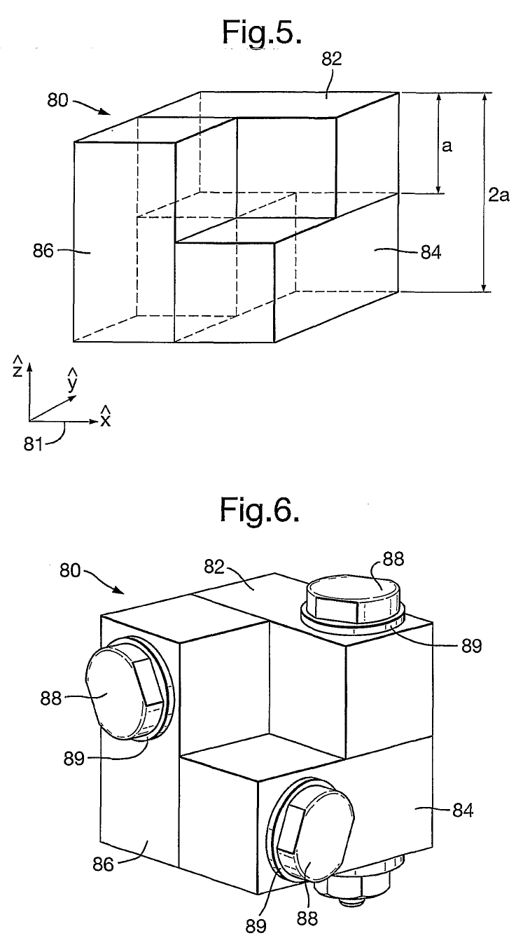

FIG. 5 shows a mould having two internal corner-cubes with co-located apexes;

FIG. 6 shows a clamping arrangement for the FIG. 5 mould elements;

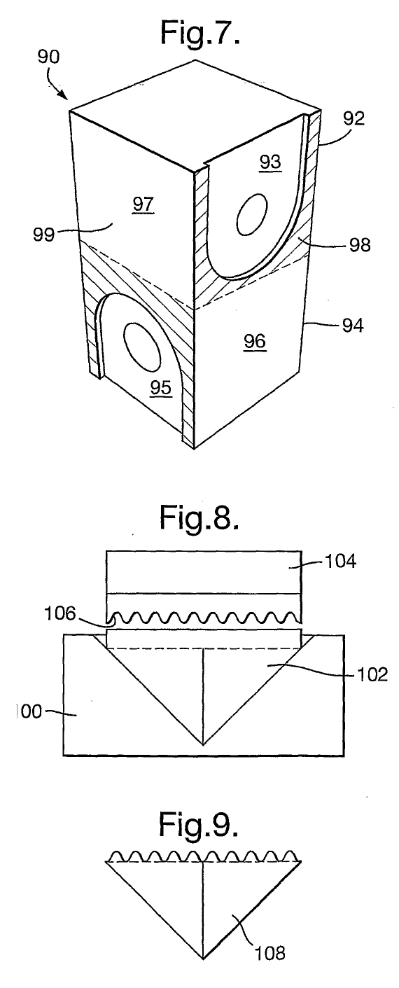

FIG. 7 shows an alternative mould element for use in the FIG. 6 mould; and

FIGS. 8 & 9 illustrate production of an external glass corner-cube having a surface pattern; and

FIG. 10 shows an optical tag of the invention.

To clarify nomenclature, in this specification an “internal corner cube”, or “hollow corner-cube”, means an object like that indicated generally by 10 in FIG. 1. The object 10 has three substantially mutually perpendicular flat, planar surfaces 12, 14, 16 defining an apex 18 which is absent any solid material. An “external corner-cube”, or “solid corner cube”, means an object like that indicated generally by 20 in FIG. 2. The solid object 20 also has three mutually perpendicular flat, planar surfaces 22, 24, 26, but in contrast to the object 10 in FIG. 1, the surfaces 22, 24, 26 define an apex 28 of solid material.

Certain optical components are required to have three flat, planar surfaces which are substantially mutually perpendicular to a high tolerance and form a solid or hollow corner-cube. For example, a solid glass corner-cube reflector is required to have three such surfaces forming a solid corner-cube, wherein adjacent surfaces intersect at 90° to a tolerance of four arc seconds or better. The corner-cube in such a reflector may be an external, or solid, corner cube, in which case in use one or more of the flat, planar surfaces retro-reflects light back into the body of the reflector. Alternatively, the corner-cube may be an internal, or hollow corner-cube, whereby light from free-space is retro-reflected back into free space. In either case the surfaces may be coated to increase reflectivity.

Components having solid or hollow corner-cubes are generally produced by a lengthy cutting and polishing process which results in a high unit cost both for the components hence also for systems and devices into which they are incorporated. Even after careful polishing, bevels exist between pairs of adjacent flat, planar surfaces; these degrade performance in certain applications, for example when the component is used as a corner-cube reflector. The fabrication of a component having an internal (hollow) corner-cube (for example for use as a hollow corner-cube reflector) is especially difficult due to the inaccessibility of surfaces to be polished.

Components having solid corner-cubes may be produced by moulding (e.g. U.S. Pat. Nos. 1,591,572 and 3,417,959) however the known moulds involve production of mould elements also having three mutually perpendicular surfaces forming a solid corner-cube. Thus, whilst allowing mass production of components having solid corner-cubes, production of such mould elements involves the same difficulties as making a finished component having a solid corner-cube by cutting and polishing techniques.

FIG. 3 shows an exploded view of a mould, indicated generally by 50, referred to rectangular coordinates 51. The mould 50 comprises first 52, second 54 and third 56 tungsten carbide mould elements. In FIG. 3, mould elements 52, 56 are shown spaced apart in the ŷ direction, mould elements 52, 54 are shown spaced apart in the \hat{z} direction and mould elements 54, 56 are shown spaced apart in the \hat{x} direction. Surfaces 52A, 52B of mould element 52 are polished to a flatness suitable for moulding planar glass surfaces of optical quality. Mould element 52 is formed so that surfaces 52A, 52B intersect at 270° to a tolerance of four arc seconds or better such that they form a solid right-angled corner 53 and are substantially mutually perpendicular. Although mould element 52 is shown in FIGS. 3 and 4 as being cuboid in shape, this is not essential and the surfaces other than 52A, 52B need not be planar or polished flat. Mould elements 54, 56 also have pairs of flat, planar surfaces 54A, 54B and 56A, 56B, the mould elements 54, 56 being polished such that surfaces 54A, 54B and 56A, 56B intersect at 270° to a tolerance of four arc seconds or better and are mutually perpendicular so that they form solid right-angled corners 55, 57 respectively. Although mould elements 54, 56 are shown in FIG. 3 as cuboids, surfaces other than 54A, 54B and 56A, 56B need not be planar or flat.

FIG. 4 shows the mould 50 in an assembled state. A first flat, planar surface of any given mould element is in contact with a flat, planar surface of a second mould element, and a second flat, planar surface of the first mould element is in contact with a flat, planar surface of a third mould element. For example, surfaces 52A, 52B of mould element 52 are in contact with surfaces 56B of mould element 56 and 54A of mould element 54, respectively. Surfaces 52A, 54A, 56A are substantially mutually perpendicular and provide an internal (hollow) corner-cube formed by right-angled corners 57, 59, 61. A solid glass corner cube may be produced by introducing a glass charge into one of the internal corner cubes of the mould 50, heating the charge so that it becomes softened, and then stamping the softened charge in the general direction of an apex of a hollow corner-cube presented by the mould 50. If the glass corner-cube is not required to have mutually perpendicular surfaces of optical quality, the flatness of the surfaces 52A, 54A, 56A may be reduced accordingly.

FIG. 5 shows another assembled mould, indicated generally by 80, comprising three mould elements 82, 84, 86. Each of the mould elements is cuboid in shape and has a length dimension substantially twice its width dimension. Each mould element has a pair of adjacent rectangular faces which are planar and polished flat to provide moulding surfaces, and which intersect at 270° with a tolerance or four arc seconds or better, such that each has a long edges presenting a solid right-angled corner. First and second moulding surfaces of a first mould element are in contact with a moulding surface of a second mould element and a moulding surface of a third mould element, respectively.

The assembled mould 80 has two internal (hollow) corner-cubes having moulding surfaces. The apexes of the internal corner-cubes are co-located. If the mould elements 82, 84, 86 have length 2a and width a, the assembled mould 80 has the form of a cube of side 2a having two smaller cubes of side a removed (thus forming the internal corner-cubes), the smaller cubes lying on a diagonal of the cube of side 2a. The mould 80 allows simultaneous moulding of two solid glass corner cubes.

FIG. 6 illustrates one scheme for clamping mould elements 82, 84, 86 together in which adjacent mould elements are clamped together using bolts 89 and fastening nuts (not shown). Any given mould element has two holes passing through it, one passing through each cubic half. The two holes passing through a mould element are substantially orthogonal and each is dimensioned to receive a bolt 88. Each mould element is clamped to two adjacent mould elements by respective bolts 88 and fastening nuts. The bolts 88 are made of a material having a coefficient of thermal expansion greater than that of the mould elements 82, 84, 86. The bolts 88 are provided with washers 89 made of a material having a higher coefficient of thermal expansion than that of the material of the bolts 88 so that the mould elements 82, 84, 86 remain firmly clamped together when the mould 80 is heated. Alternatively, the bolts 88 may be made of a material having a coefficient of thermal expansion less than that of the material of the mould elements, obviating the need for washers.

FIG. 7 shows an alternative mould element 90, three of which may be used to assemble the mould 80 of FIG. 6. The mould element 90 has a form substantially the same as each of the mould elements 82, 84, 86 except that the mould element 90 has two central recesses 93, 95 on respective adjacent rectangular faces 98, 99, and on respective cubic halves 92, 94 of the mould element 90. To assemble the mould 80, the recessed square half of the rectangular face 99 of the mould element 90 is placed in contact with the recessed square half of a rectangular face of a second such mould element such that the two mould elements are orthogonal. Similarly, the recessed square half of the rectangular face 98 of the mould element 90 is placed in contact with the recessed square half of a rectangular face of a third such mould element such that these two mould elements are orthogonal. The non-recessed square halves 96, 97 of the adjacent rectangular faces 98, 99 each become one side of a respective internal corner cube of the mould 80. The recesses 93, 95 reduce the common area of contact between adjacent mould elements, thus reducing the possibility that particles of dust or dirt become trapped between adjacent mould elements when the mould 80 is assembled, thus misaligning the mould elements and reducing the orthogonality of the corner-cube. The shape of the recesses may vary from that shown in FIG. 7, however the non-recessed portions (shown shaded in FIG. 7) of the square halves of the rectangular faces having the recesses must be shaped such that surfaces of the elements forming the corner cube are mutually orthogonal.

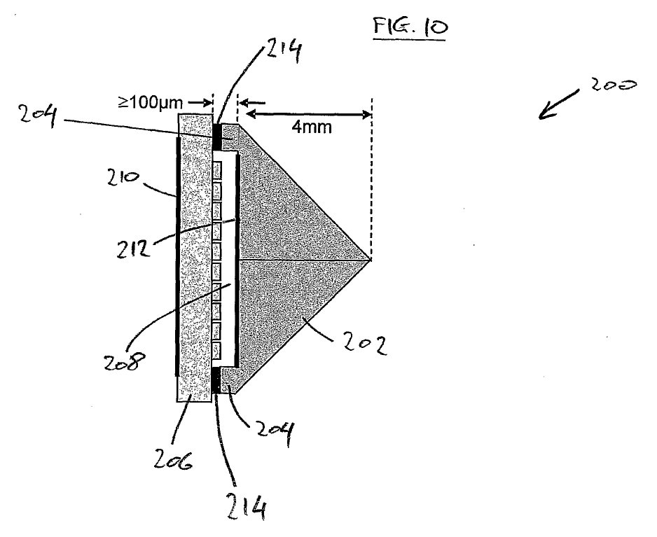

Referring to FIGS. 8 and 9, a mould 100 of the invention having an internal (hollow) corner-cube contains a softened glass charge 102. A stamping element 104 having a corrugated stamping surface 106 is used to stamp the charge 102 into the corner cube, to produce a solid glass corner cube 108 having an anti-reflection surface, such as a moth-eye surface. A solid glass corner-cube having a desired surface pattern may therefore be produced in a single step using a mould of the invention.

The moulds of FIGS. 4, 5 and 6 may be adapted for use as internal corner-cube reflectors. For example, metal or dielectric reflective coatings may be applied to the surfaces 52A, 54A, 56A of the mould 50 of FIG. 4. If both internal corner-cubes are provided with reflective coatings, then two internal corner-cube reflectors are produced, the reflectors having apexes which are exactly co-located. Such an arrangement is useful in certain interferometric techniques.

A monolithic glass component having two internal corner-cubes may be produced by taking three glass elements equivalent to the mould elements 52, 54, 56 of FIG. 3 and fusing them together using heat and pressure to produce a monolithic glass component having the form of the assembled mould 50 of FIG. 5. The surfaces forming the internal corner-cube may be coated to enhance reflectivity if required. In order to avoid misalignment caused by trapping of dust or dirt prior to fusing, the glass elements may be provided with central recesses as shown in FIG. 7.

FIG. 10 shows an optical tag of the invention, indicated generally by 200. The tag 200 comprises a moulded solid glass corner-cube reflector 202 made by the moulding process described above. The corner-cube reflector 202 has a moulded peripheral flange 214 by which it is bonded to a silicon MEMS modulator 206 by a thin region of glass material 214 having a lower softening temperature (e.g. 50 to 100 degree C. lower) than that of the corner-cube reflector 202. The face of the MEMS modulator 206 remote from the corner-cube reflector 202 carries an AR coating 210. The corner-cube reflector 202 also has an AR coating 212. The peripheral flange 204 of the corner-cube reflector 202 provides a ˜100 μm space 208 which is evacuated.

In use of the optical tag 200, interrogating light from a remote laser is incident on the tag 200 at the AR coating 210 and passes through the modulator 206. After retro-reflection by the corner-cube 202, light transmitted by the MEMS modulator 206 passes back through the modulator 206 and propagates away from the tag 200.

To fabricate the tag 200, a layer of glass material 214 several microns thick is deposited by a conventional sputtering process either around the edge of the silicon MEMS modulator 206 or onto the peripheral flange 204 of the corner-cube reflector 202, or both. Adhesion of the glass material 214 to the MEMS modulator 206 and to the corner-cube reflector 202 may be assisted by providing roughened surfaces. These can easily be provided on the silicon MEMS modulator 206 as part its fabrication process and on the corner-cube 202 during the moulding process by which it is made.

The silicon MEMS modulator 206 and the corner-cube reflector 202 are heated under vacuum to a temperature above the softening temperature of the of the glass material 214 and a force is applied to the components 202, 206 causing the glass material 214 to flow slightly and fuse them together. The fused components are then cooled slowly through the glass transition temperature of the glass material 214 to create a single (integrated) vacuum encapsulated component 200.

As an alternative to sputtering the glass material 214 onto the modulator 206 and/or the corner-cube reflector 202, an annular fillet of glass material 214 may be placed between these components prior to the application of heat and force. If the annular fillet has an appropriate thickness, there is no need for the corner-cube 202 to have a moulded peripheral flange 204.

As described above, the AR coating 212 could be substituted by a moth eye pattern applied during moulding of the corner-cube 202. The AR coating 210 on the silicon MEMS modulator 206 may be formed either by application of a conventional dielectric coating or by embossing a moth-eye pattern (as described above) into a thin layer of infrared glass deposited onto the silicon.

In the latter case, a glass would need to be chosen that has a refractive index as close to that of silicon (˜3.4) as possible and preferably with good optical transmission at 1.5 μm. Such glasses are readily available.

1. An optical tag comprising modifying means arranged to modify at least one property of light incident thereon and an associated corner-cube reflector arranged to reflect light output by said means away from the optical tag, wherein said reflector is a chalcogenide glass corner-cube reflector.

2. An optical tag according to claim 1 wherein the chalcogenide glass corner-cube reflector is arranged to retro-reflect light output by the modifying means back through the modifying means.

3. An optical tag according to claim 1 wherein the chalcogenide glass corner-cube reflector is bonded to the modifying means.

4. An optical tag according to claim 3 wherein the modifying means is a silicon MEMS modulator.

5. An optical tag according to claim 1 and comprising a plurality of modifying means each having an associated chalcogenide glass corner-cube reflector.

6. An optical tag according to claim 1 wherein the chalcogenide glass corner-cube reflector is made by the steps of:
(i) introducing a chalcogenide glass charge into a mould having three mutually orthogonal moulding surfaces forming an internal corner-cube;
(ii) heating the chalcogenide glass charge to form a softened chalcogenide glass charge; and
(iii) stamping the softened chalcogenide glass charge into the internal corner-cube in the general direction of the apex thereof to produce an external chalcogenide glass corner-cube.

7. An optical tag according to claim 6 wherein the three mutually orthogonal surfaces of the chalcogenide glass-corner cube are each provided with a reflective coating, preferably a coating of metal or dielectric.

8. An optical tag according to claim 6 wherein the softened chalcogenide glass charge is stamped so as to produce a surface of optical quality on the side of the chalcogenide glass charge remote from the external corner-cube whereby an optical window is produced which allows light to pass to the resulting corner-cube.

9. An optical tag according to claim 8 wherein the softened chalcogenide glass charge is stamped such that the surface is flat.

10. An optical tag according to claim 8 wherein the softened chalcogenide glass charge is stamped such that the surface is curved.

11. An optical tag according to claim 10 wherein the surface has spherical curvature.

12. An optical tag according to claim 8 wherein the softened chalcogenide glass charge is stamped such that said surface is textured so as to provide an optical function.

13. An optical tag according to claim 12 wherein the softened chalcogenide glass charge is stamped such that said function is an anti-reflection function.

14. An optical tag according to claim 13 wherein the softened chalcogenide glass charge is stamped such that said surface is provided with a moth-eye pattern.

15. An optical tag according to claim 8 wherein the softened chalcogenide glass charge is stamped so that said surface is provided with a peripheral raised edge.

16. An optical tag according to claim 4 wherein the chalcogenide glass corner-cube reflector is bonded to the silicon MEMS modulator by the steps of:
(i) introducing glass material between the chalcogenide glass corner-cube reflector and the silicon MEMS modulator, the glass material having a softening temperature less than that of the chalcogenide glass corner-cube reflector;
(ii) placing the corner-cube reflector, the glass material and the silicon MEMS modulator in contact;
(iii) heating the corner-cube reflector, the glass material and the silicon MEMS modulator to a temperature above the softening temperature of the glass material; and
(iv) applying force to allow the corner-cube reflector, the glass material and the silicon MEMS modulator to fuse together under heating.

17. An optical tag according to claim 16 wherein step (i) is performed by sputtering glass material onto at least a portion of a surface of the glass corner-cube reflector.

18. An optical tag according to claim 16 wherein step (i) is performed by sputtering glass material onto at least a portion of the silicon MEMS modulator.

19. An optical tag according to claim 16 wherein step (i) is performed by introducing a glass fillet between the corner-cube reflector and the silicon MEMS modulator.

20. An optical tag according to claim 16 wherein steps (iii) and (iv) are performed under vacuum.
